(19) United States
(12) Patent Application Publication
(10) Pub. No.: US 2026/0107035 A1
(43) Pub. Date: Apr. 16, 2026

(54) CONTENT ITEM PLACEMENT SUGGESTIONS FOR SCRIPTED MEDIA CONTENT

(71) Applicant: Roku, Inc., San Jose, CA (US)

(72) Inventors: Rohit Sai Venkataramana Nyayapati, Santa Clara, CA (US); Michael Patrick Cutter, Golden, CO (US); Sunil Ramesh, Saratoga, CA (US); Nicholas Lineback, Denver, CO (US); Thejaswi Raya, Fremont, CA (US)

(21) Appl. No.: 18/916,281

(22) Filed: Oct. 15, 2024

(51) Int. Cl. H04N 21/431; H04N 21/235

(52) U.S. Cl. CPC H04N 21/4316; H04N 21/2353

(57) ABSTRACT

Provided are system, apparatus, device, method and/or computer-program product embodiments, combinations and/or sub-combinations thereof for determining, using an artificial intelligence (AI) model, content item placements based on text information associated with scripted content. An example method can include receiving textual information descriptive of one or more scenes associated with media content and, based on the textual information, determining, by an AI model, one or more contextual attributes of each scene from the one or more scenes. The method can include, based on the contextual attributes, determining one or more content placement locations within the one or more scenes, the one or more content placement locations depicting at least one of an object, an activity, and a dialogue. The method can further include generating one or more suggested content modifications for the at least one of the object, the activity, and the dialogue in the one or more content placement locations.

### BACKGROUND

### FIELD

This disclosure is generally directed to media content processing and management, and more particularly to using artificial intelligence to extract features from media content scripts and using the extracted features to determine locations to place or insert content items within media content generated based on the media content scripts.

### SUMMARY

Provided herein are system, apparatus, article of manufacture, method and/or computer program product embodiments, and/or combinations and sub-combinations thereof, for determining, using an artificial intelligence (AI) model, content item placements based on text information associated with scripted media content.

In some aspects, a method is provided for determining content item placements based on text information of media content. The method can operate by receiving textual information descriptive of one or more scenes associated with media content. In some cases, the method can further include, based on the textual information, determining, by an artificial intelligence model, one or more contextual attributes of each scene from the one or more scenes. In some examples, the method can also include based on the one or more contextual attributes, determining one or more content placement locations within the one or more scenes. In some aspects, the one or more content placement locations depict at least one of an object, an activity, and a dialogue. In some cases, the method can further include generating one or more suggested content modifications for the at least one of the object, the activity, and the dialogue in the one or more content placement locations within the one or more scenes.

In some aspects, a system is provided for determining content item placements based on text information of media content. The system can include one or more memories and at least one processor coupled to at least one of the one or more memories and configured to receive textual information descriptive of one or more scenes associated with media content. The at least one processor of the system can be configured to, based on the textual information, determine, by an artificial intelligence model, one or more contextual attributes of each scene from the one or more scenes. The at least one processor of the system can also be configured to, based on the one or more contextual attributes, determine one or more content placement locations within the one or more scenes. In some aspects, the one or more content placement locations depict at least one of an object, an activity, and a dialogue. The at least one processor of the system can be configured to generate one or more suggested content modifications for the at least one of the object, the activity, and the dialogue in the one or more content placement locations within the one or more scenes.

In some aspects, a non-transitory computer-readable medium is provided for determining content item placements based on text information of media content. The non-transitory computer-readable medium can have instructions stored thereon that, when executed by at least one computing device, cause the at least one computing device to receive textual information descriptive of one or more scenes associated with media content. The instructions of the non-transitory computer-readable medium can, when executed by the at least one computing device, cause the at least one computing device to, based on the textual information, determine, by an artificial intelligence model, one or more contextual attributes of each scene from the one or more scenes. The instructions of the non-transitory computer-readable medium can, when executed by the at least one computing device, cause the at least one computing device to, based on the one or more contextual attributes, determine one or more content placement locations within the one or more scenes. In some aspects, the one or more content placement locations depict at least one of an object, an activity, and a dialogue. The instructions of the non-transitory computer-readable medium can, when executed by the at least one computing device, cause the at least one computing device to generate one or more suggested content modifications for the at least one of the object, the activity, and the dialogue in the one or more content placement locations within the one or more scenes.

### BRIEF DESCRIPTION OF THE FIGURES

The accompanying drawings are incorporated herein and form a part of the specification.

FIG. 1 is a block diagram illustrating an example multimedia environment, according to some examples of the present disclosure.

FIG. 2 is a block diagram illustrating an example streaming media device, according to some examples of the present disclosure.

FIG. 3 illustrates a diagram illustrating an example architecture of an example content item management system for generating content item placement suggestions for scripted media content, according to some examples of the present disclosure.

FIG. 4 illustrates a diagram illustrating an example system for generating a content item that modifies a scene of media content, according to some examples of the present disclosure.

FIG. 5 illustrates a flowchart of an example method for generating suggested content modifications based on text information of media content, according to some examples of the present disclosure.

FIG. 6 illustrates a flowchart of an example method for identifying content item placements for scripted media content, according to some examples of the present disclosure.

FIG. 7 illustrates a flowchart of an example method for generating suggested content modifications for scripted media content, according to some examples of the present disclosure.

FIG. 8A is a diagram illustrating an example of a neural network architecture, according to some examples of the present disclosure.

FIG. 8B is a diagram illustrating another example architecture that can be used to implement a large language model, according to some examples of the present disclosure.

FIG. 9 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Users access and consume media content such as videos, at any time of day or any location, using a wide variety of client devices such as, for example, and without limitations, smart phones, desktop computers, laptop computers, tablet computers, televisions (TVs), IPTV receivers, media devices, monitors, projectors, smart wearable devices, appliances, and Internet-of-Things (IoT) devices, among others. The media content may be accessible on various platforms across diverse channels by a wide range of viewers.

The media content can include, for example and without limitation, one or more (and/or any combination of) videos (e.g., live, pre-recorded, or on-demand videos, streamed videos, movies, television programs, any sequence of video frames or graphics, etc.), video games, audio (e.g., radio programs, audiobooks, podcasts, etc.), text, images, still pictures, among other types. Many media contents are produced based on pre-written scripts such as, for example, detailed/comprehensive scripts that include dialogue, actions, and/or scene directions for videos such as movies or TV shows; or general scripts that provide guidelines for content such as talk shows or reality shows.

In some cases, media content can include a content item(s) placed/inserted within the media content such as, for example and without limitation, an image, a video, an animation, and/or an invitational content item (e.g., an advertisement) that depicts, describes, announces, promotes, identifies, and/or relates to a product(s), a service(s), a brand(s), an event(s), a message(s), and/or any other item. For example, content providers can make content placement determinations to identify locations within media content (e.g., a video or video feed, a video game or video game feed, streamed media content, a live broadcast, etc.) where a content item(s) or object(s) can be placed or inserted within the media content. The content providers can use the content placement determinations (e.g., the identified locations) to modify the media content to insert the content item(s) or object(s) for presentation with (e.g., within, as part of, along with, etc.) the media content. As another example, product placement based on content placement determinations can be used as a marketing strategy to insert a content item relating to a product within media content (e.g., a product embedded into a setting of a scene) presented to a user in order to provide offers to the user and/or promote the product (and/or an associated brand, service, etc.). However, the manual identification of content item placement locations is difficult, labor-intensive, time-consuming, and unscalable. Indeed, in many cases, it may even be unfeasible to manually identify content placement locations for a large amount/volume of content or content items.

For example, prior to media content production, it can be very difficult, labor-intensive, and time-consuming to manually check a pre-written script for potential content item placement locations within the media content generated according to the pre-written scrip, and generate modifications or adjustments to the generated media content in order to add or substitute an object, a dialogue, an action, or a scene associated with a potential content item placement location to include a content item selected for that content placement location. Further, after the production of the media content, it may be similarly difficult, labor-intensive, and time-consuming to manually identify a potential content item placement location(s) within the media content and replace or modify a portion of the media content associated with the potential content item placement location(s) to embed a content item therewithin.

Provided herein are system, apparatus, device, method (also referred to as a process) and/or computer program product embodiments, combinations and/or sub-combinations thereof (also referred to as “systems and techniques” hereinafter) for automating content placement determinations based on scripts used to produce or generate media content such as videos. For example, in some aspects, the systems and techniques described herein can use artificial intelligence (AI) or machine learning (ML) to extract features associated with media content (e.g., videos, etc.) from text scripts used to produce (and/or used when producing) the media content, and can use the extracted features to determine locations within the media content used to place or insert content items within the media content generated based on the text scripts.

For example, in some cases, some media content may be produced based on or according to scripts that describe features of the media content such as, for example, any plots conveyed by the media content the systems, any activities depicted in the media content, any scenes depicted in the media content, any speech/dialogue in the media content, any events depicted in the media content, any characters depicted in the media content, any contexts depicted in the media content, and/or any other features of the media content. The systems and techniques described herein can use the scripts associated with certain media content to determine, using an AI/ML model, content item placement locations within the media content produced based on or according to such scripts.

In some examples, the systems and techniques described herein can use an AI model to determine content item placement locations within media content based on text information included in a script used to produce the media content and/or describe any aspects of the media content. For example, the AI model can easily and efficiently identify (e.g., in an automated fashion) content item placement locations within media content based on a textual description of one or more scenes associated with the media content. The text description can be included in a script associated with the media content. The AI model can recognize text in the script and the meaning of the text in the script in order to determine information about the media content based on the text in the script. The information determined from the script and used to determine content placement locations can include any features associated with the media content such as, for example and without limitation, contextual features, a plot(s), an event(s), a scene(s), an object(s), a character(s), a dialogue/speech, a condition(s), an interaction(s), an activity, etc. The AI model can use the information determined from the script to understand the content and any other aspects of the media content, which the AI model can use to intelligently identify content placement locations within the media content. The content placement locations can be used to determine where to place/insert a selected content item (e.g., an image, a video, an advertisement, an animation, text, an object, etc.) within the media content and/or modify content from the content placement locations according to the selected content item (e.g., by replacing the content with the selected content item, modifying the content to depict the selected content item, or otherwise modifying the content based on the selected content item).

In some examples, the systems and techniques described herein can use a large language model (LLM) to extract features from text data in a script used to (or to be used to) produce a media content item, which the LLM can use to understand the media content item associated with the script and make content placement decisions. The text data in the script can describe any features/aspects of the media content item such as, for example, one or more scenes, events, activities, characters, interactions, utterances, objects, contexts, conditions, plots, etc. The LLM can analyze and process the text data in the scripts to recognize the text, understand any syntax, semantics, contexts, and/or sentiments of the language used in the script to describe features/aspects of the media content item, and detect such features/aspects of the media content item.

In some examples, the systems and techniques described herein can determine, using an AI model, contextual attributes of one or more shots and/or scenes in media content based on the text data in a script used to produce the media content (and/or define any aspects of the content included in the media content). For example, an LLM model can determine contextual attributes or features of each scene in a media content item (e.g., a video, etc.) by performing natural language processing (NLP) and/or natural language understanding (NLU) to recognize and/or understand text in a script associated with the media content item, which can describe one or more aspects/features of the media content item, such as scenes depicted in the media content item. The contextual attributes can include, for example and without limitation, a genre, a character(s), a gender of the character(s), an age of the character(s), a relationship between characters, a background audio, a sentiment, an ambient, a geo-location, an activity, an event, a condition in a scene, an object in a scene (and/or a saliency of an object in a scene such as a relevance, prominence, and/or importance of an object in the media content). For example, based on the natural language analysis of text describing a scene in a media content item that depicts a character buying running shoes, an LLM model can determine that the media content item includes a scene depicting a character buying running shoes and/or other aspects of the associated content, such as a sentiment of the scene depicting the character buying running shoes (e.g., negative, neutral, or positive opinions) and/or saliency of the running shoes depicted in the media content.

In some aspects, the systems and techniques described herein can identify content placement locations within scenes depicted in a media content item based on the contextual attributes of each scene. The content placement locations may indicate, within the media content, slots or places where a content item can be placed within the media content in addition to or in lieu of any features in the content associated with such slots or places, such as an object, an activity, or a dialogue depicted by the content associated with such slots or places. In the illustrative example of a scene depicting a character buying running shoes, the systems and techniques described herein can identify the running shoes depicted in the scene as a content placement location for a content item associated with (or selected for) running shoes. For example, the systems and techniques described herein can replace or modify a visual representation of that the running shoes in the media content to instead depict running shoes of a particular brand in order to advertise such running shoes within the scene.

In some cases, the systems and techniques described herein generate suggested content modifications for any content (e.g., an object, activity, event, character, context, dialogue, interactions, etc.) associated with (e.g., depicted in/by) the content placement locations. For example, if the textual information in a script for media content includes a description of a scene where a character is drinking at a restaurant, the systems and techniques described herein can recognize/detect the scene with the character drinking at the restaurant based on the textual information in the script, and use such information to identify the scene (or a portion of the scene such as a portion depicting the character, the restaurant, what the character is drinking, etc.) as a content placement location and generate a suggestion to replace the content depicting the drink that the character in the scene is drinking with an invitational content item associated with a particular drink or drink brand such as, for example, an invitation content item depicting a specific (and/or a specific brand of) water, juice, soft drink, coffee, beer, wine, and so on. In some instances, for media content that includes a video frame corresponding to a scene described in a textual script, the systems and techniques described herein can use a generative AI model to insert the invitational content item onto the video frame. For example, the generative AI model can modify the scene where a character is drinking water to replace a portion of the content depicting the water that the character is drinking with content depicting a soft drink from a particular brand, for example.

As discussed in further detail below, the systems and techniques described herein can improve the efficiency, scalability, and effectiveness of identifying content item placements within media content by processing text information descriptive of the media content (e.g., a script) and provide seamless integration of content items into the media content. Also, the systems and techniques described herein can enable content items to be integrated into media content at a production phase (and/or any other phase) based on information about the media content determined from a text associated with the media content, such as a script used during the production phase.

### Example Multimedia Environment

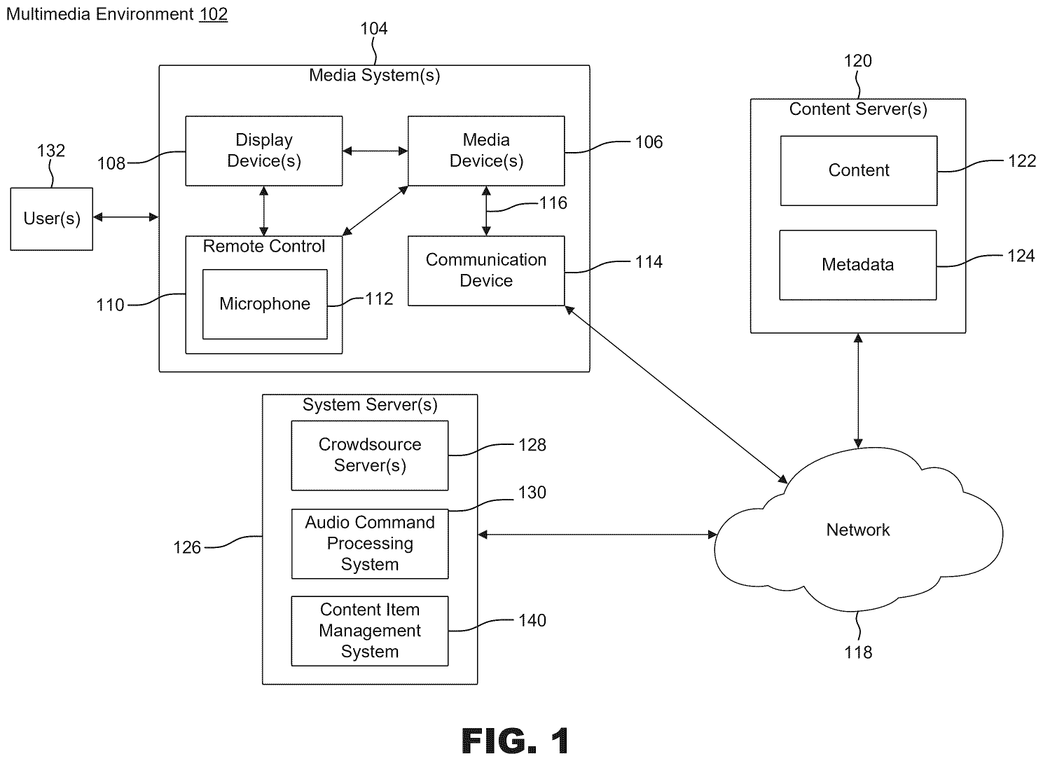

FIG. 1 illustrates a block diagram of a multimedia environment 102, according to some embodiments. In a non-limiting example, multimedia environment 102 may be directed to media content, such as streaming media, a conversational AI system implemented by one or more devices, and interactions with media devices and display systems using the conversation AI system. However, this disclosure is applicable to any type of media (instead of or in addition to media content and interactions with media devices and display systems), as well as any mechanism, means, protocol, method and/or process for distributing media content, interacting with media devices, and/or implementing conversational systems for interacting with various devices.

The multimedia environment 102 may include a media system(s) 104. The media system(s) 104 can include one or more media systems, and each media system can include and/or represent a family room, a kitchen, a backyard, a home theater, a school classroom, a library, a car, a boat, a bus, a plane, a movie theater, a stadium, an auditorium, a park, a bar, a conference room, a home, an entertainment room, a restaurant, an office, or any other location or space where it is desired to receive and play media content, such as streaming content. A user(s) 150 may operate the media system(s) 104 to select and consume content. The user(s) 140 can include or represent one or more users in multimedia environment 102.

The media system(s) 104 may include a media device(s) 106. The media device(s) 106 can be coupled to a display device(s) 108. The media device(s) 106 can include one or more media devices, the display device(s) can include one or more media devices, and each media device can be coupled to a display device (or multiple display devices) from the one or more display devices. It is noted that terms such as “coupled,” “connected to,” “attached,” “linked,” “combined” and similar terms may refer to physical, electrical, magnetic, logical, etc., connections, unless otherwise specified herein.

The media device(s) 106 may be or include one or more streaming media devices, DVDs or BLU-RAY devices, audio/video playback devices, cable boxes, gaming systems, televisions, head-mounted display (HMD) devices, set-top boxes, video display devices, and/or digital video recording devices, to name just a few non-limiting examples. Display device(s) 108 may include or be part of one or more monitors, televisions (TVs), desktop computers, laptop computers, mobile phones (e.g., smartphones), tablet computers, wearable devices (e.g., a smartwatch, an HMD, smartglasses, etc.), screens, appliances, internet-of-things (IoT) devices, SBCs or SoCs, and/or projectors, to name just a few non-limiting examples. In some examples, the media device(s) 106 can be a part of, integrated with, operatively coupled to, and/or connected to one or more respective display devices, such as the display device(s) 108.

The media device(s) 106 may be configured to communicate with network 118 via a respective communication device 114. The communication device 114 may include, for example, a cable modem or satellite TV transceiver. The media device(s) 106 may communicate with the communication device 114 over a link 116. The link 116 may include wireless (such as WiFi) and/or wired connections.

In various examples, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system(s) 104 may include a remote control(s) 110. The remote control(s) 110 can be any component, part, apparatus and/or method for controlling the media device(s) 106 and/or display device(s) 108, such as a remote control, a tablet, laptop computer, mobile phone (e.g., smartphone), wearable, on-screen controls, integrated control buttons, audio controls, or any combination thereof, to name just a few examples. In some examples, the remote control(s) 110 can wirelessly communicate with the media device(s) 106 and/or display device(s) 108 using cellular, Bluetooth, infrared, WIFI, WIFI direct, etc., or any combination thereof. The remote control(s) 110 may include a microphone(s) 112, which is further described below.

The multimedia environment 102 may include content server(s) 120 (also called content provider(s), channel(s) or source(s)). Content server(s) 120 can represent one or more content servers. Although only one content server is shown in FIG. 1, in practice, the multimedia environment 102 may include any number of content servers. The content server(s) 120 may be configured to communicate with network 118.

The content server(s) 120 may store content 122 and metadata 124. Content 122 may include any combination of music, videos, movies, video games, television (TV) programs, multimedia, images, still pictures, text, graphics, gaming applications, advertisements, programming content, public service content, government content, local community content, targeted media content, software, and/or any other content or data objects in electronic form. In some examples, content 122 can include video frames, such as sequences of video frames representing videos, audio content (e.g., audio assets or files, audio signals, etc.), text content (e.g., closed captions, subtitles, text transcriptions, intertitles, superimposed text, onscreen text, etc.), context data, device data, historical data, and/or any other data described herein. In some cases, a portion of content 122 may include a content item (e.g., a video, an audio, or a text that promotes or is otherwise associated with a product, service, business, brand, and/or event). For example, content 122 may include a content item (e.g., an advertisement), which can be inserted within a plurality of video frames.

In some examples, metadata 124 can include data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media system(s) 104. Accordingly, the media devices 106 may lend themselves to crowdsourcing embodiments and, thus, the system servers 126 may include one or more crowdsource servers 128.

For example, using information received from the media devices 106 in the thousands and millions of media system(s) 104, the crowdsource server(s) 128 may identify similarities and overlaps between closed captioning requests issued by different users 132 watching a particular movie. Based on such information, the crowdsource server(s) 128 may determine that turning closed captioning on may enhance users'viewing experience at particular portions of the movie (for example, when the soundtrack of the movie is difficult to hear), and turning closed captioning off may enhance users'viewing experience at other portions of the movie (for example, when displaying closed captioning obstructs critical visual aspects of the movie). Accordingly, the crowdsource server(s) 128 may operate to cause closed captioning to be automatically turned on and/or off during future streamings of the movie.

The system servers 126 may also include an audio command processing system 130. As noted above, the remote control 110 may include a microphone 112. The microphone 112 may receive audio data from users 132 (as well as other sources, such as the display device 108). In some examples, the media device 106 may be audio responsive, and the audio data may represent verbal commands from the user 132 to control the media device 106 as well as other components in the media system(s) 104, such as the display device 108.

In some examples, the audio data received by the microphone 112 in the remote control 110 is transferred to the media device 106, which is then forwarded to the audio command processing system 130 in the system servers 126. The audio command processing system 130 may operate to process and analyze the received audio data to recognize the user 132's verbal command. The audio command processing system 130 may then forward the verbal command back to the media device 106 for processing.

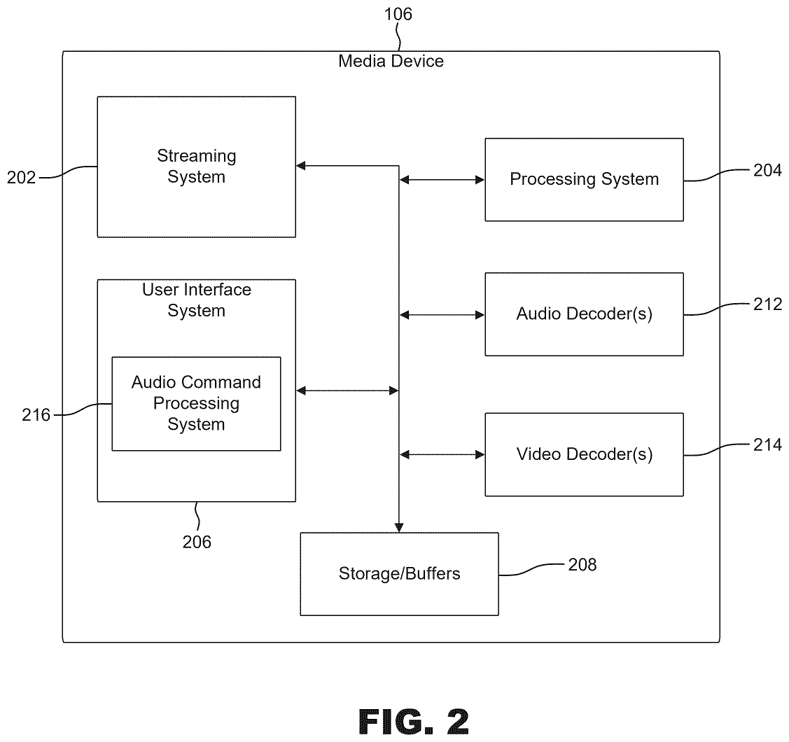

In some examples, the audio data may be alternatively or additionally processed and analyzed by an audio command processing system 216 in the media device 106 (see FIG. 2). The media device 106 and the system servers 126 may then cooperate to pick one of the verbal commands to process (either the verbal command recognized by the audio command processing system 130 in the system servers 126, or the verbal command recognized by the audio command processing system 216 in the media device 106).

In some aspects, system server(s) 126 may also include content item management system 140 for automating content placement determinations based on scripts used to produce or generate media content such as videos (e.g., content 122). The content item management system 140 use AI or ML to extract features associated with content 122 from text scripts used to produce (and/or used when producing) the content 122, and can use the extracted features to determine locations within the content 122 used to place or insert content items within the content 122 generated based on the text scripts.

FIG. 2 illustrates a block diagram of an example media device 106, according to some embodiments. Media device 106 may include a streaming system 202, processing system 204, storage/buffers 208, and user interface module 206. As described above, the user interface module 206 may include the audio command processing system 216.

The media device 106 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, VVC, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, VVC, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some examples, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming system 202 of the media device 106 may request the selected content from the content server(s) 120 over the network 118. The content server(s) 120 may transmit the requested content to the streaming system 202. The media device 106 may transmit the received content to the display device 108 for playback to the user 132.

In streaming examples, the streaming system 202 may transmit the content to the display device 108 in real time or near real time as it receives such content from the content server(s) 120. In non-streaming examples, the media device 106 may store the content received from content server(s) 120 in storage/buffers 208 for later playback on display device 108.

### Content Item Placements for Scripted Media Content

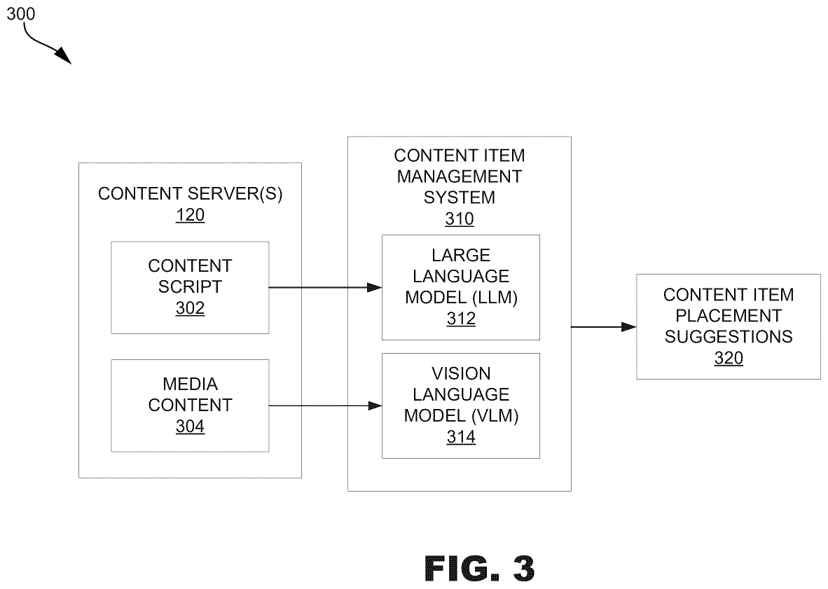

FIG. 3 is an example architecture 300 of an example content item management system 310 for generating content item placement suggestions 320 for scripted media content using an AI model, according to some examples of the present disclosure. In some cases, content item management system 310 can include, represent, and/or be implemented by one or more servers from the system server(s) 126 shown in FIG. 1 such as content item management system 140. In some cases, content item management system 310 (and/or a copy or version thereof) can additionally or alternatively include, represent, and/or be implemented by any software and/or component(s) on the media device(s) 106 shown in FIG. 2. For example, in some cases, content item management system 310 can be implemented by processing system 204 of media device(s) 106 shown in FIG. 2. Moreover, content item management system 310 can implement one or more AI/ML models used to process content script 302 and media content 304 to generate content item placement suggestions 320. In this example shown in FIG. 3, content item management system 310 can include large language model (LLM) 312 and video language model (VLM) 314, which content item management system 310 can use to process content script 302 and media content 304 and generate content item placement suggestions 320.

In some examples, a server (e.g., content server(s) 120) can be configured to store content script 302 and/or media content 304. For example, in some cases, the content 122 in content server(s) 120 can include content script 302 and/or media content 304. In another example, the content 122 in content server(s) 120 can include media content 304, and the metadata 124 in content server(s) 120 can include content script 302. Content script 302 can include a text description of any details of media content 304 (and/or a content of media content 304 such as any scenes, events, objects, activities, conditions, contexts, interactions, dialogues, characters, and/or other features included or depicted in media content 304. For example, in some cases, content script 302 for media content 304 (e.g., movies, TV programs, radio programs, podcasts, online videos, or other digital content) can include textual information describing any dialogue, actions, scenes, sound effects, contexts, utterances, interactions, music cues, camera directions (for video), locations, characters, transitions, timing, voiceover, lighting cues, conditions, dialogues, credits, titles, metadata, special effects, and/or any textual descriptions relating to media content production. In some examples, content script 302 may include a specific description of any the above-listed elements of media content. In other examples, content script 302 can additionally or optionally include a general description of guidelines for media content production (e.g., in bullet points).

Media content 304 can include sequences of video frames representing videos and/or other media content (e.g., movies, TV programs, radio programs, podcasts, online videos, or other digital content). The media content 304 can include video frames depicting one or more scenes, which can be described in content script 302. As previously described, content server(s) 120 can store metadata associated with media content 304 such as ancillary information indicating or related to a writer, director, producer, composer, artist, actor, summary, chapters, production, history, year, trailers, alternate versions, related content, applications, content identifier, content attributes, and/or any other information pertaining or relating to media content 304.

In some examples, content item management system 310 can be configured to process (e.g., via LLM 312) text data from content script 302, which describes details of media content 304. The LLM 312 of content item management system 310 can perform natural language processing (e.g., natural language understanding) on the text data to understand the meaning, intent, content, and/or context of or associated with the text data. The natural language processing performed by LLM 312 can include, for example and without limitation, text processing, semantic parsing, semantic analysis, intent understanding, contextual understanding, sentiment analysis, and/or text classification, among others. In an illustrative example, LLM 312 can use the text data from content script 302 to understand the intent and meaning of dialogue or actions described in content script 302.

In some aspects, content item management system 310 can be configured to process media content 304 using an AI model, such as VLM 314. For example, VLM 314 of content item management system 310 can process video data (e.g., video/image frames) and natural language data (e.g., text and/or text transcripts) in media content 304 and analyze the video data to understand the relationship between visual information depicted by media content 304 (e.g., what is seen/depicted), audio information (e.g., what is heard/output) associated with media content 304 (e.g., speech/dialogue, utterances, music, and/or other audio of media content 304) and text information associated with media content 304 (e.g., subtitles, closed captions, metadata, intertitles, superimposed text, etc.). The VLM 314 can, via visual and linguistic understanding, detect and recognize features (e.g., objects, actions, activities, scenes, events, conditions, etc.) depicted in the video data (e.g., video frames) of media content 304.

The content item management system 310 can use features extracted or recognized from content script 302 and media content 304 to generate content item placement suggestions 320 and identify candidate locations within media content 304 to insert content items and/or to modify based on the content items. For example, LLM 312 can process content script 302 to extract features from content script 302 which LLM 312 can use to understand media content 304 and/or recognize any details/elements included in, associated with, and/or depicted within media content 304. VLM 314 can process media content 304 to extract features from media content 304, such as scenes, activities, characters, events, objects, dialogue, interactions, conditions, etc. Based on the features obtained from content script 302 and media content 304, content item management system 310 can generate content item placement suggestions 320. In some examples, content item placement suggestions 320 can include one or more recommendations or indications of potential content item placement locations (e.g., product placement) within media content 304 that can be used to place/insert certain content items and/or identify associated content that can be modified based on certain content items (e.g., to include, resemble, or mirror such content items, etc.). In some cases, the potential content item placement locations can include slots or regions of content described in content script 302 and/or depicted in media content 304, locations within one or more scenes that are described in content script 302 and/or depicted in media content 304, objects described in content script 302 and/or depicted in media content 304, and/or any other content elements described in content script 302 and/or depicted in media content 304.

The content item management system 310 can use the features extracted from content script 302 to identify or flag a region(s) or scene(s) within media content 304 where a content item (e.g., invitational content item) can be potentially added or that can be modified to depict one or more aspects of the content item (or the entire content item). For example, content item placement suggestions 320 can include a recommended modification to content within media content 304, such as an object, an activity, a scene, and/or a dialogue in media content 304. In some examples, the recommended modification can include a recommendation to add new content (e.g., a new or different object, activity, scene, and/or dialogue) within the content (e.g., within the object, activity, scene, and/or dialogue identified in the recommended modification) or replace the content identified in the recommended modification with the new content (e.g., the new or different object, activity, scene, and/or dialogue). In one illustrative example, for a scene where a character is cooking with pots in a kitchen, the content item placement suggestions 320 may include a suggestion for modifying the scene to add cookware from a particular brand to show the character using the cookware in the scene, modifying the cooking scene into a cleaning scene and depicting cleaning supplies from a particular brand within the cleaning scene, substituting the portion of content depicting the pots to instead depict pans from a particular brand, among others.

In some examples, content item placement suggestions 320 can include information about characteristics of a content item associated with the content placement locations identified in the content item placement suggestions 320, such as a content genre; a content duration; a frequency of appearances of an object, an activity, and/or a dialogue in the media content 304; one or more content constraints (e.g., an indication that a particular object, activity, or dialogue cannot be modified, size and/or shape constraints for content to be replaced or modified, types of content that should not be modified, types of contents that should not be included in a modification, etc.), and so on. For example, in the above-illustrated example of the cooking scene, content item management system 310 can provide the time duration of the activity (e.g., cooking) in the scene or a number of times that the activity (e.g., cooking) appears throughout the media content 304, etc.

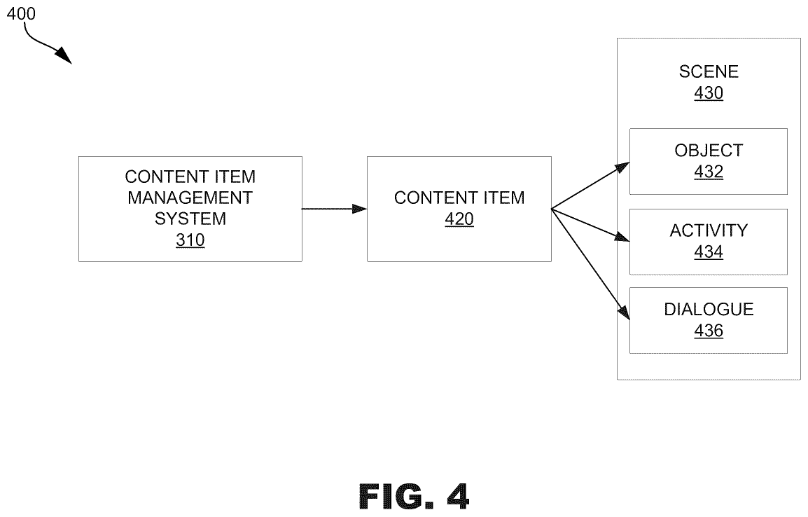

FIG. 4 illustrates an example system 400 for generating a content item that modifies a scene of media content, according to some examples of the present disclosure. In this example, content item management system 310 can obtain or generate content item 420. The content item 420 can include any content or content features. However, for illustration and explanation purposes, the content item 420 in FIG. 4 includes an object 432, an activity 424, and/or a dialogue 436. The object 432, activity 424, and/or dialogue 436 in the content item 420 can be added to scene 430 within respective content placement locations (e.g., from content item placement suggestions 320) identified by content management system 310 as previously described with respect to FIG. 3, or used to replace an object, an activity, and/or a dialogue included in scene 430. Scene 430 can represent a scene depicted in media content (e.g., media content 304) and associated with (e.g., corresponding to or containing) one or more content item placement locations identified by content management system 310 as previously described with respect to FIG. 3.

In some examples, content item management system 310 can use a generative vision model to fill in an object, an object, and/or a dialogue with a content item (e.g., an invitational content item such as an advertised product or service). For example, content item management system 310 can use a generative AI model (not shown) to substitute an object depicted in scene 430 with object 432 from content item 420. In another example, content item management system 310 can, using a generative AI model, replace a water bottle depicted in scene 430 with a wine bottle from a particular brand. In other examples, content item management system 310 can generate, using a generative AI model, a new frame within content item 420 that includes or represents a version of a frame associated with scene 430. The new frame can be used to replace the frame associated with scene 420, which consequently can replace content (e.g., an object, an activity, a dialogue, etc.) within the frame with other content, such as content depicting the object 432, activity 424, and/or dialogue 436.

In some cases, content item 420 can include an interactive element, which may provide information about the object, the activity, and/or the dialogue recommended in content item placement suggestions 320. For example, in the above-illustrated example of the cooking scene, content item placement suggestions 320 can include a link (e.g., URL link) where a user can purchase the pans or cleaning supplies.

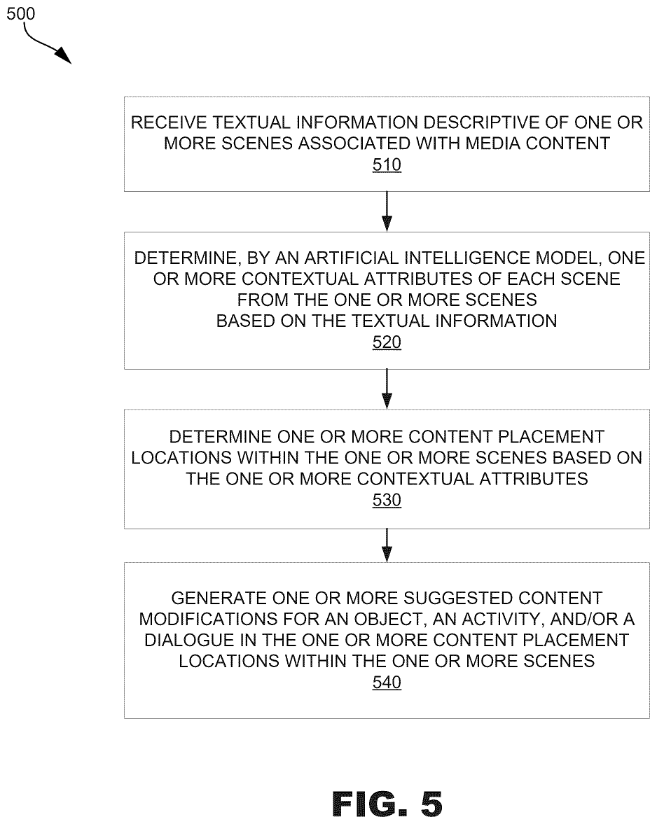

FIG. 5 is a diagram illustrating a flowchart of an example method 500 for generating suggested content modifications based on text information of media content. The method 500 can be done by a server or back-end/cloud system, or by a client (or a client device). Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIGS. 3 and 4. However, method 500 is not limited to those examples.

In step 510, content item management system 310 can receive textual information descriptive of one or more scenes associated with media content. For example, content item management system 310 can receive content script 302, which may include text description of any details of media content (e.g., content 122, media content 304) such as movies, TV programs, radio programs, podcasts, online videos, or other digital content). As previously described, content script 302 (e.g., a pre-written script) may include textual information describing any dialogue, actions, scenes, sound effects, contexts, utterances, interactions, music cues, camera directions (for video), locations, characters, transitions, timing, voiceover, lighting cues, conditions, dialogues, credits, titles, metadata, special effects, and/or any textual descriptions relating to media content production. For example, content script 302 can provide a detailed text description of a scene depicting two characters dining at a restaurant, such as a type of cuisine that they order, background music in the restaurant, a conversation about the food or the restaurant, and so on.

In step 520, content item management system 310 can determine one or more contextual attributes of each scene from the one or more scenes based on the textual information. For example, content item management system 310 can determine, using an AI model (e.g., LLM 312), one or more shots and/or scenes in media content 304 based on the text description in a script used to produce the media content 304 (and/or define any aspects of the media content 304 included in the media content 304). The LLM 312 can process the text data from content script 302 (e.g., text description depicting details of media content 304) to understand the meaning, intent, content, and/or context of or associated with the text data. Non-limiting examples of contextual attributes can include a genre, a character(s), a gender of the character(s), an age of the character(s), a relationship between characters, a background audio, a sentiment, an ambient, a geo-location, an activity, an event, a condition in a scene, an object in a scene (and/or a saliency of an object in a scene such as a relevance, prominence, and/or importance of an object in the media content). In the illustrated example of the restaurant scene, content item management system 310 can use LLM 312 to ingest content script 302 and determine various attributes or features associated with the scene, such as an ambient in the restaurant, a relationship between the characters, a level of saliency of foods or restaurant with respect to the plot, among others.

In step 530, content item management system 310 can determine one or more content placement locations within the one or more scenes based on the one or more contextual attributes. For example, content item management system 310 can identify potential content item placement locations within media content 304 that can be used to place/insert certain content items and/or identify associated content that can be modified based on certain content items (e.g., to include, resemble, or mirror such content items, etc.). The content placement locations may indicate slots or regions of content described in content script 302 and/or depicted in media content 304, locations within one or more scenes that are described in content script 302 and/or depicted in media content 304, objects described in content script 302 and/or depicted in media content 304, and/or any other content elements described in content script 302 and/or depicted in media content 304.

In step 540, content item management system 310 can generate one or more suggested content modifications for the object, the activity, and/or the dialogue in the one or more content placement locations within the one or more scenes. In some examples, content item management system 310 can generate content item placement suggestions 320, which include a recommended modification to content within media content 304, such as an object, an activity, a scene, and/or a dialogue in media content 304. In some examples, the recommended modification can include a recommendation to add new content (e.g., a new or different object, activity, scene, and/or dialogue) within the content (e.g., within the object, activity, scene, and/or dialogue identified in the recommended modification) or replace the content identified in the recommended modification with the new content (e.g., the new or different object, activity, scene, and/or dialogue). For example, in a scene where a character is driving a car, content item management system 310 can identify the scene as a potential content placement location and generate a recommendation that a car in the scene can be modified or replaced with a vehicle from a particular brand.

In some aspects, content item management system 310 can obtain or generate content item placement suggestions 320, which include a content item (e.g., content item 420) that may be inserted or added at the suggested location. For example, content item management system 310 can generate, using a generative AI model, any content or content features such as object 432, activity 434, and/or a dialogue 436. The object 432, activity 434, and/or dialogue 436 in the content item 420 can be added to scene 430 within respective content placement locations (e.g., from content item placement suggestions 320). In the example of the driving scene, content item management system 310 can use a generative AI model to fill in the car in the original scene with a new vehicle.

In some examples, content item management system 310 can update suggested content modifications based on user data associated with a target audience for the media content. For example, content item management system 310 can update content item placement suggestions 320 based on any information about a target audience for media content, such as user demographics (e.g., age, sex, geographic location, income, generation, occupation, etc.), user preferences (e.g., genre, casts, length of content, etc.), a geographic location, privacy settings, viewing history or viewing patterns, social media activities, and so on. For example, if a target audience for media content 304 includes a minor or teenager, content item placement suggestions 320 can be updated to include a family restaurant instead of a bar, soft drinks instead of alcoholic beverages, among others.

In some aspects, content item management system 310 can update suggested content modifications based on auxiliary data associated with the media content, for example and without limitation, a cast of the media content, a sponsor of the media content, a target geographic region of the media content, among others. For example, content item management system 310 can update content item placement suggestions 320 to include a product from a sponsor of the media content to be added to the scene. In some cases, auxiliary data can be obtained from content script 302, media content 304, or metadata 124.

In some cases, content item management system 310 can update suggested content modifications based on rules that prohibit one or more types of content being used to modify the object, the activity, and/or the dialogue. If a target geographic location or region of media content 304 has rules or restrictions that prohibit certain types of content from being shown or included in media content (e.g., cigarettes or smoking scene, etc.), content item management system 310 can update content item placement suggestions 320 to comply the rules or restrictions accordingly.

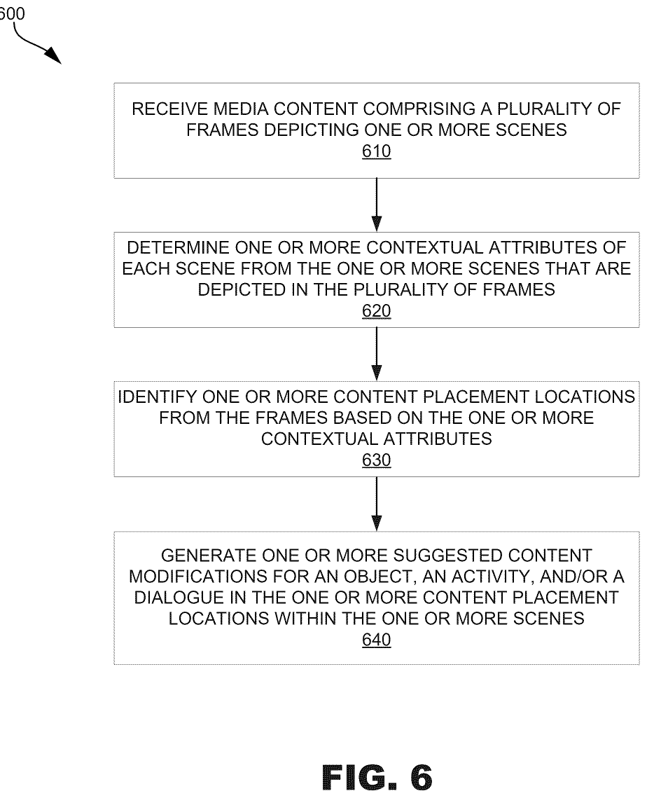

FIG. 6 is a diagram illustrating a flowchart of an example method 600 for identifying content item placements for scripted media content. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to FIGS. 3 and 4. However, method 600 is not limited to those examples.

In step 610, content item management system 310 can receive media content comprising a plurality of frames depicting one or more scenes. For example, content item management system 310 can receive media content 304 comprising a plurality of frames (e.g., video frames) depicting one or more scenes. In some examples, media content 304 (e.g., movies, TV programs, podcasts, online videos, or other digital content) is produced/filmed based on content script 302. For example, video frames of media content 304 correspond to scenes that are described in content script 302.

In step 620, content item management system 310 can determine one or more contextual attributes of each scene from the one or more scenes that are depicted in the plurality of frames, for example using an AI model (e.g., VLM 314). For example, VLM 314 of content item management system 310 can process video data (e.g., video/image frames) and natural language data (e.g., text and/or text transcripts) in media content 304. The VLM 314 can analyze the video data to detect and recognize features (e.g., objects, actions, activities, scenes, events, conditions, etc.) depicted in the video data (e.g., video frames) of media content 304 and further determine various contextual attributes such as a genre, a relationship between characters, a sentiment, an ambient, a geo-location, and/or a saliency of an object in a scene (e.g., a relevance or importance of an object to a plot of the media content).

In step 630, content item management system 310 can identify one or more content placement locations from the frames based on the one or more contextual attributes. For example, content item management system 310 can, using VLM 314, one or more candidate content placement locations from the frames of media content 304 based on the one or more contextual attributes. The content item management system 310 can identify, among the plurality of video frames, one or more frames as content placement location where a content item (e.g., an invitational content item) can be integrated into the scene that is depicted in the frames based on the features that are extracted or recognized from media content 304 at step 630.

In step 640, content item management system 310 can generate one or more suggested content modifications for an object, an activity, and/or a dialogue in the one or more content placement locations within the one or more scenes. For example, content item management system 310 can generate, using a generative AI model, content item 420 to substitute an object, activity, and/or dialogue included in a scene with object 432, activity 434, and/or dialogue 436 from content item 420.

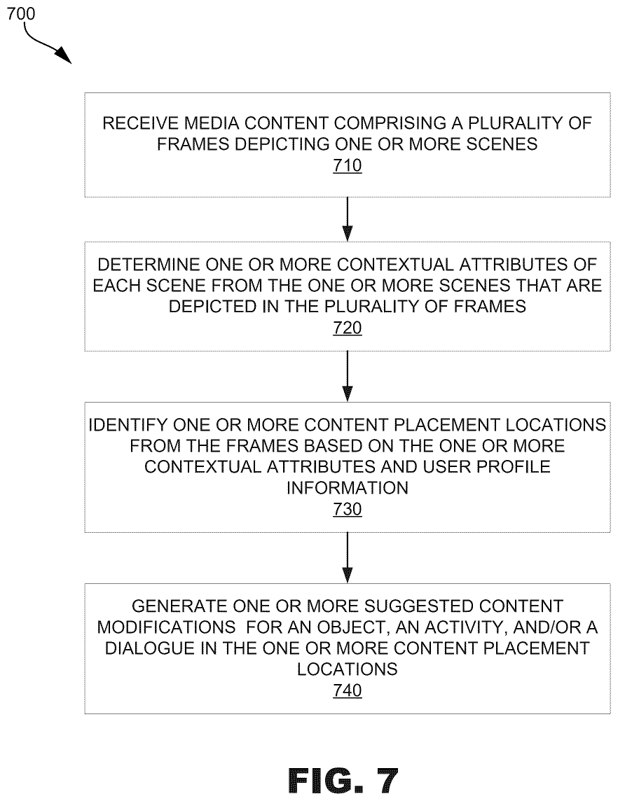

FIG. 7 is a diagram illustrating a flowchart of an example method 700 for generating suggested content modifications for scripted media content. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art.

Method 700 shall be described with reference to FIGS. 3 and 4. However, method 400 is not limited to those examples.

In step 710, a client device implementing content item management system 310 can receive media content comprising a plurality of frames depicting one or more scenes. For example, media device 106 implementing content item management system 310 can receive media content 304 comprising a plurality of frames (e.g., video frames) depicting one or more scenes. The media content 304 can include any form of content that may be produced based on a script, such as movies, TV programs, radio programs, podcasts, online videos, or other digital content.

In some aspects, media device 106 can also receive textual information descriptive of the scenes associated with media content 304 and be used for natural language processing to enhance the identification of content placement locations and generation of suggested content modifications as described below.

In step 720, a client device implementing content item management system 310 can determine one or more contextual attributes of each scene from the one or more scenes that are depicted in the plurality of frames. For example, media device 106 implementing content item management system 310 can determine, using an AI model, one or more contextual attributes of each scene from the one or more scenes that are depicted in the plurality of frames of media content 304. The LLM 312 can process content script 302 to extract features from content script 302 which LLM 312 can use to understand media content 304 and/or recognize any details/elements included in, associated with, and/or depicted within media content 304. VLM 314 can process media content 304 to extract features from media content 304, such as scenes, activities, characters, events, objects, dialogue, interactions, conditions, etc.

In step 730, a client device implementing content item management system 310 can identify one or more content placement locations from the frames based on the one or more contextual attributes. Further, a client device implementing content item management system 310 (e.g., media device 106) can identify user-specific content placement locations from the frames based on user profile information. The user profile information can include any information about and/or a user (e.g., user 150) such as user preferences, a user profile(s), user settings, user inputs, user inputs, user account information, user location information, user demographics, viewing history or viewing patterns, user-specific device and/or application profiles, social media activities, etc.

In step 740, a client device implementing content item management system 310 can generate one or more suggested content modifications for an object, an activity, and/or a dialogue in the one or more content placement locations based on the user profile information. For example, media device 106 implementing content item management system 310 can generate customized or personalized content item placement suggestions 320 or content item 420 for an object, an activity, and/or a dialogue. The client device (e.g., media device 106) can locally obtain information about user inputs, feedback, user interactions, viewing history, state of the device, IoT data, and so on. As follows, by leveraging user information that may be available locally, content item management system 310 can identify content item placement locations and generate suggestions or content item that is tailored to a user.

### Example Neural Network Architectures and Models

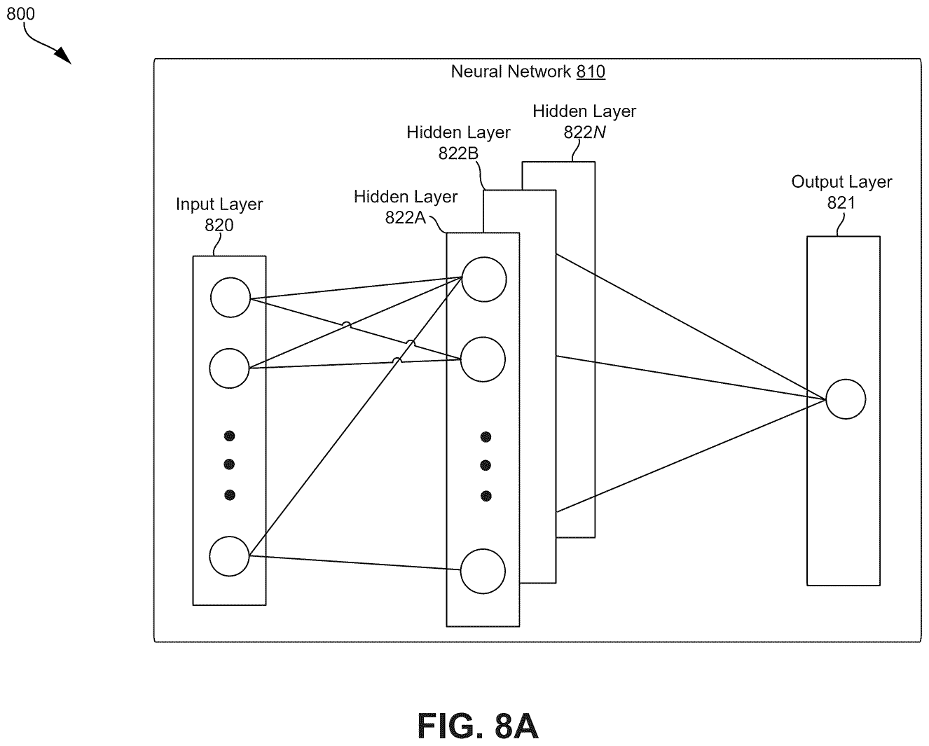

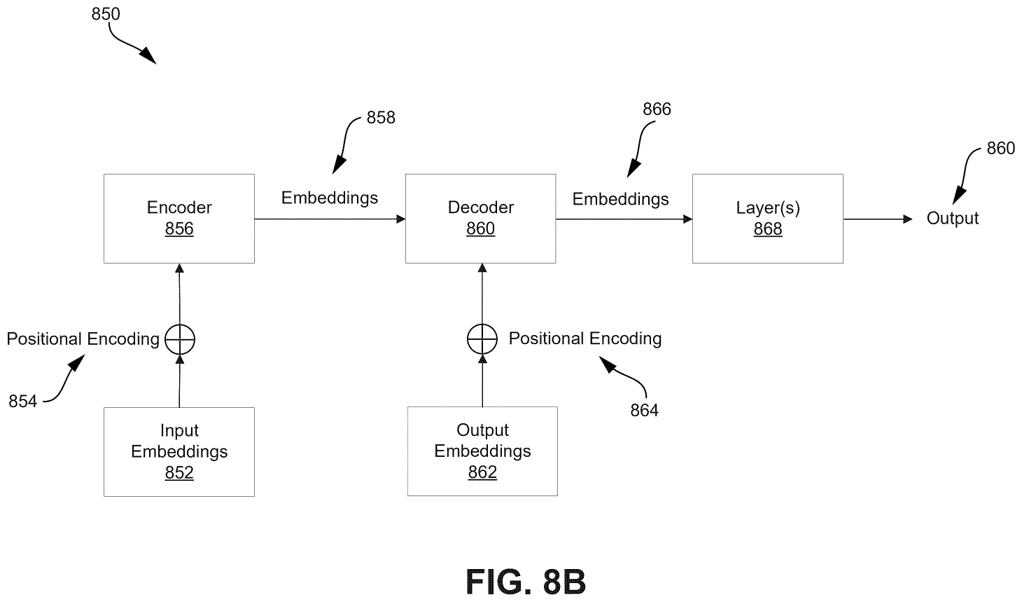

FIG. 8A is a diagram illustrating an example architecture 800 of an example neural network 810. The example architecture 800 can be used to implement any neural network described herein and/or any components described herein that can include or implement a neural network. For example, the architecture 800 can be used to implement content item management system 310, LLM 312, and/or VLM 314.

The architecture 800 of the neural network 810 can include an input layer 820 that can be configured to receive and process data to generate one or more outputs. The architecture 800 of the neural network 810 can also include hidden layers 822a, 822b, through 822n. The hidden layers 822a, 822b, through 822n include “n” number of hidden layers, where “n” is an integer greater than or equal to one. The number of hidden layers can be made to include as many layers as needed for the given application. The architecture 800 of the neural network 810 can further include an output layer 821 that provides an output resulting from the processing performed by the hidden layers 822a, 822b, through 822n.

The neural network 810 is a multi-layer neural network of interconnected nodes. Each node can represent a piece of information. Information associated with the nodes is shared among the different layers and each layer retains information as information is processed. In some cases, the neural network 810 can include a feed-forward network, in which case there are no feedback connections where outputs of the network are fed back into itself. In some cases, the neural network 810 can include a recurrent neural network, which can have loops that allow information to be carried across nodes while reading in input.

Information can be exchanged between nodes through node-to-node interconnections between the various layers. Nodes of the input layer 820 can activate a set of nodes in the first hidden layer 822a. For example, as shown, each of the input nodes of the input layer 820 is connected to each of the nodes of the first hidden layer 822a. The nodes of the first hidden layer 822a can transform the information of each input node by applying activation functions to the input node information. The information derived from the transformation can then be passed to and can activate the nodes of the next hidden layer 822b, which can perform their own designated functions. Example functions include convolutional, up-sampling, data transformation, and/or any other suitable functions. The output of the hidden layer 822b can then activate nodes of the next hidden layer, and so on. The output of the last hidden layer 822n can activate one or more nodes of the output layer 821, at which an output is provided. In some cases, while nodes in the neural network 810 are shown as having multiple output lines, a node can have a single output and all lines shown as being output from a node represent the same output value.

In some cases, each node or interconnection between nodes can have a weight that is a set of parameters derived from the training of the neural network 810. Once the neural network 810 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network 810 to be adaptive to inputs and able to learn as more and more data is processed.

The neural network 810 is pre-trained to process the features from the data in the input layer 820 using the different hidden layers 822a, 822b, through 822n in order to provide the output through the output layer 821.

In some cases, the neural network 810 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 810 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=Σ(½(target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 810 can perform a backward pass by determining which inputs (weights) most contributed to the loss of the network and can adjust the weights so that the loss decreases and is eventually minimized.

The neural network 810 can include any suitable deep network. One example neural network includes a transformer network, which can be used to implement a large language model such as LLM 312 or VLM 314. Another example neural network includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 810 can include any other deep network other than a transformer or CNN, such as a encoder-decoder network, an encoder-only network, a decoder-only network, a mixture of experts (MoE) network, a generative model network, an autoencoder, Deep Belief Nets (DBNs), Recurrent Neural Networks (RNNs), among others.

As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 8B is a diagram illustrating an example architecture of an example transformer model 850, according to some examples of the present disclosure. The transformer model 850 can be used to implement an LLM, such LLM 312. As shown, the transformer model 850 can include input embeddings 852 used as inputs to the transformer model 850. The input embeddings 852 can include input values representing words and/or sentences, such as numbers or vectors representing words and/or sentences.

In some cases, the input embeddings 852 can function like a dictionary that helps the transformer model 850 understand the meaning of words by placing them in an embedding space where similar words are located near each other. In some examples, the input interface 134 can be trained and/or configured to create the input embeddings 852 so that similar vectors represent words with similar meanings. In some examples, the transformer model 850 can additionally or alternatively learn to create and/or process the input embeddings 852 during training.

The transformer model 850 can use positional encoding 854 to encode the position of each word in an input sequence from the input embeddings 852 as values such as a set of numbers, a vector, etc. The values generated by the positional encoding 854 can be fed into the transformer model 850 along with the input embeddings 852. By incorporating the positional encoding 854 into the transformer model 850, the transformer model 850 can more effectively understand the order of words in a sentence and generate grammatically correct and semantically meaningful output.

The transformer model 850 can include an encoder(s) 856 used to process the positionally encoded input embeddings 852 and generate embeddings 858. The encoder(s) 856 can be part of the transformer model 850 that processes input text and generates hidden states that capture the meaning and context of the text. For example, the encoder(s) 856 can include a feed-forward neural network that is part of the transformer model 850. In some examples, the encoder(s) 856 can implement multiple encoder layers. In some cases, the encoder(s) 856 can first tokenize the input text into a sequence of tokens, such as individual words or subwords. The encoder(s) 856 can then apply one or more self-attention layers, which can generate hidden states that represent the input text at different levels of abstraction. In this way, the encoder(s) 856 can generate the embeddings 858 (e.g., a vector, a set of values, etc.) representing the semantics and position of words in one or more sentences.

The transformer model 850 can include output embeddings 862, which can include values representing words and/or sentences, such as numbers or vectors representing words and/or sentences. The output embeddings 862 can be similar to the input embeddings 852 and can also be processed by positional encoding 864 to encode the position of each word in a sequence from the output embeddings 862 as values such as a set of numbers, a vector, etc., which helps the transformer model 850 understand the order of words in a sentence. The output embeddings 862 can be used during a training phase of the transformer model 850 and can be used during an inference phase. During training, a loss function can be computed based on the output embeddings 862 and used to update the model parameters to improve the accuracy of the transformer model 850. During an inference phase, the output embeddings 862 can be used to generate the output text by mapping the predicted probabilities determined by the transformer model 850 for each token to the corresponding token in the vocabulary.

The positionally encoded input embeddings 852 (e.g., the embeddings 858) and the positionally encoded output embeddings 862 can be fed to a decoder(s) 860 used to generate the output sequence based on the encoded input sequence. During training, the decoder(s) 860 can learn how to guess the next word of a sequence by looking at the words before it. In some examples, the decoder(s) 860 can generate natural language text based on the input sequence and any learned context.

The decoder(s) 860 can generate embeddings 866 and feed the embeddings 866 to one or more network layers 868. In some examples, the one or more network layers 868 can include a linear layer and a softmax function. The linear layer can map the embeddings 866 generated by the decoder(s) 860 to a higher-dimensional space, which can transform the embeddings 866 into the original input space. The softmax function can then be applied to generate a probability distribution for each output token in the vocabulary, which can result in an output 870. In some examples, the output 870 can include output tokens with probabilities.

### Example Computer System

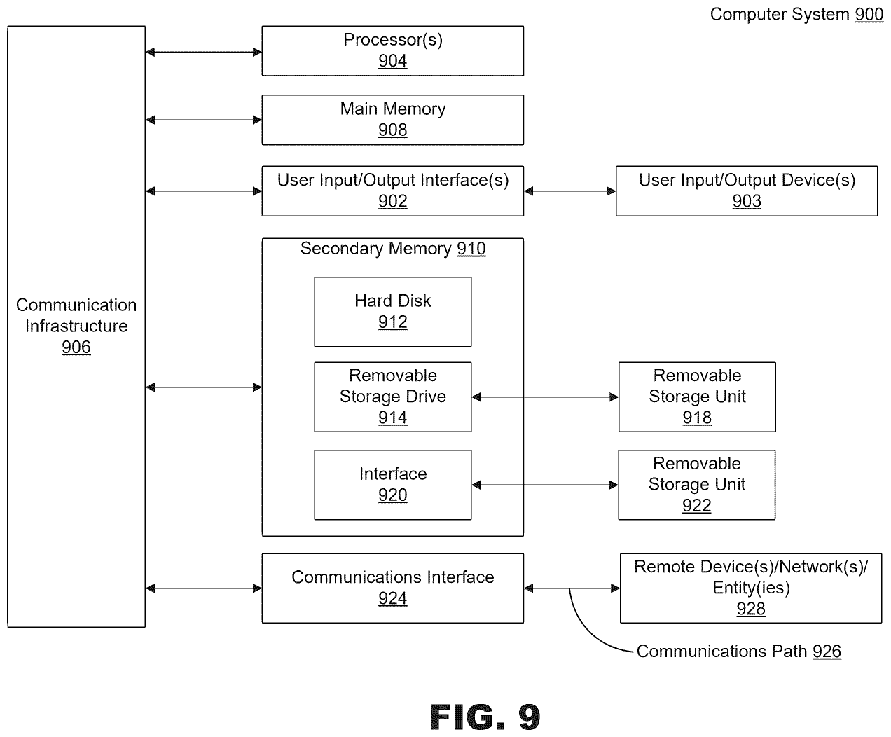

Various aspects and examples may be implemented, for example, using one or more well-known computer systems, such as computer system 900 shown in FIG. 9. For example, content item management system 310 may be implemented using combinations or sub-combinations of computer system 900. Also or alternatively, one or more computer systems 900 may be used, for example, to implement any of the aspects and examples discussed herein, as well as combinations and sub-combinations thereof.

Computer system 900 may include one or more processors (also called central processing units, or CPUs), such as a processor 904. Processor 904 may be connected to a communication infrastructure or bus 906.

Computer system 900 may also include user input/output device(s) 903, such as monitors, keyboards, pointing devices, etc., which may communicate with communication infrastructure 906 through user input/output interface(s) 902.

One or more of processors 904 may be a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (e.g., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 may include a computer usable or readable storage device having stored thereon computer software (control logic) and/or data. Removable storage unit 918 may be a floppy disk, magnetic tape, compact disk, DVD, optical storage disk, /d/ any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 900 may include a communication or network interface 924. Communication interface 924 may enable computer system 900 to communicate and interact with any combination of external devices, external networks, external entities, etc. (individually and collectively referenced by reference number 928). For example, communication interface 924 may allow computer system xx00 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communications path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900 or processor(s) 904), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

### Illustrative Examples of the Disclosure Include

Aspect 1. A system comprising: memory; and one or more processors coupled to the memory and configured to perform operations comprising: receiving textual information descriptive of one or more scenes associated with media content; based on the textual information, determining, by an artificial intelligence model, one or more contextual attributes of each scene from the one or more scenes; based on the one or more contextual attributes, determining one or more content placement locations within the one or more scenes, the one or more content placement locations depicting at least one of an object, an activity, and a dialogue; and generating one or more suggested content modifications for the at least one of the object, the activity, and the dialogue in the one or more content placement locations within the one or more scenes.
Aspect 2. The system of Aspect 1, wherein the media content comprises a plurality of frames, and wherein the one or more processors are configured to perform operations further comprising: based on a determination that the one or more scenes are depicted in one or more frames from the plurality of frames, identifying the one or more content placement locations from the one or more frames depicting the one or more scenes, wherein the one or more frames also depict the at least one of the object, the activity, and the dialogue.
Aspect 3. The system of Aspect 2, wherein the one or more processors are configured to perform operations further comprising: replacing, using a generative model, the object in the one or more frames with content associated with the one or more suggested content modifications.
Aspect 4. The system of any of Aspects 1 to 3, wherein the one or more suggested content modifications comprise one or more content characteristics comprising at least one of a content genre, a content duration, a frequency of appearances of the object, the activity, and the dialogue in the media content, and one or more content constraints.
Aspect 5. The system of any of Aspects 1 to 4, wherein the one or more contextual attributes comprise at least one of a genre of each scene, one or more characters in each scene, a relationship between characters in each scene, a gender of the one or more characters, an age of the one or more characters, a background audio of each scene, a sentiment of each scene, an ambient of each scene, and a geo-location of each scene.
Aspect 6. The system of any of Aspects 1 to 5, wherein the one or more processors are configured to perform operations further comprising: receiving user data associated with a target audience for the media content; and updating the one or more suggested content modifications based on the user data.
Aspect 7. The system of any of Aspects 1 to 6, wherein the one or more processors are configured to perform operations further comprising: updating the one or more suggested content modifications based on auxiliary data comprising at least one of a cast of the media content, a sponsor of the media content, and a target geographic region of the media content.
Aspect 8. The system of any of Aspects 1 to 7, wherein the one or more suggested content modifications comprise an interactive element providing information associated with the at least one of the object, the activity, and the dialogue.
Aspect 9. The system of any of Aspects 1 to 8, wherein the one or more processors are configured to perform operations further comprising: updating the one or more suggested content modifications based on rules that prohibit one or more types of content being used to modify the at least one of the object, the activity, and the dialogue.
Aspect 10. A method comprising: receiving textual information descriptive of one or more scenes associated with media content; based on the textual information, determining, by an artificial intelligence model, one or more contextual attributes of each scene from the one or more scenes; based on the one or more contextual attributes, determining one or more content placement locations within the one or more scenes, the one or more content placement locations depicting at least one of an object, an activity, and a dialogue; and generating one or more suggested content modifications for the at least one of the object, the activity, and the dialogue in the one or more content placement locations within the one or more scenes.
Aspect 11. The method of Aspect 10, wherein the media content comprises a plurality of frames, and the method further comprises: based on a determination that the one or more scenes are depicted in one or more frames from the plurality of frames, identifying the one or more content placement locations from the one or more frames depicting the one or more scenes, wherein the one or more frames also depict the at least one of the object, the activity, and the dialogue.
Aspect 12. The method of Aspect 11, further comprising: replacing, using a generative model, the object in the one or more frames with content associated with the one or more suggested content modifications.
Aspect 13. The method of any of Aspects 10 to 12, wherein the one or more suggested content modifications comprise one or more content characteristics comprising at least one of a content genre, a content duration, a frequency of appearances of the object, the activity, and the dialogue in the media content, and one or more content constraints.
Aspect 14. The method of any of Aspects 10 to 13, wherein the one or more contextual attributes comprise at least one of a genre of each scene, one or more characters in each scene, a relationship between characters in each scene, a gender of the one or more characters, an age of the one or more characters, a background audio of each scene, a sentiment of each scene, an ambient of each scene, and a geo-location of each scene.
Aspect 15. The method of any of Aspects 10 to 14, further comprising: receiving user data associated with a target audience for the media content; and updating the one or more suggested content modifications based on the user data.
Aspect 16. The method of any of Aspects 10 to 15, further comprising: updating the one or more suggested content modifications based on auxiliary data comprising at least one of a cast of the media content, a sponsor of the media content, and a target geographic region of the media content.
Aspect 17. The method of any of Aspects 10 to 16, wherein the one or more suggested content modifications comprise an interactive element providing information associated with the at least one of the object, the activity, and the dialogue.
Aspect 18. The method of any of Aspects 10 to 17, further comprising: updating the one or more suggested content modifications based on rules that prohibit one or more types of content being used to modify the at least one of the object, the activity, and the dialogue.
Aspect 19. A non-transitory computer-readable medium having instructions stored thereon that, when executed by one or more processors, cause the one or more processors to perform a method according to any of Aspects 10 to 18.
Aspect 20. A system comprising means for performing a method according to any of Aspects 10 to 18.
Aspect 21. A computer-program product comprising computer-executable instructions which, when executed by one or more processors, cause the one or more processors to perform a method according to any of Aspects 10 to 18.

1. A system comprising:
memory; and
one or more processors coupled to the memory and configured to perform operations comprising:
receiving content script text descriptive of one or more scenes associated with media content, the content script text being external to the media content;
based on the content script text, determining, by an artificial intelligence model, one or more contextual attributes of each scene from the one or more scenes;
based on the one or more contextual attributes, determining one or more content placement locations within the one or more scenes, the one or more content placement locations depicting at least one of an object, an activity, and a dialogue; and
generating one or more suggested content modifications for the at least one of the object, the activity, and the dialogue in the one or more content placement locations within the one or more scenes.

2. The system of claim 1, wherein the media content comprises a plurality of frames, and wherein the one or more processors are configured to perform operations further comprising:
based on a determination that the one or more scenes are depicted in one or more frames from the plurality of frames, identifying the one or more content placement locations from the one or more frames depicting the one or more scenes, wherein the one or more frames also depict the at least one of the object, the activity, and the dialogue.

3. The system of claim 2, wherein the one or more processors are configured to perform operations further comprising:
replacing, using a generative model, the object in the one or more frames with content associated with the one or more suggested content modifications.

4. The system of claim 1, wherein the one or more suggested content modifications comprise one or more content characteristics comprising at least one of a content genre, a content duration, a frequency of appearances of the object, the activity, and the dialogue in the media content, and one or more content constraints.

5. The system of claim 1, wherein the one or more contextual attributes comprise at least one of a genre of each scene, one or more characters in each scene, a relationship between characters in each scene, a gender of the one or more characters, an age of the one or more characters, a background audio of each scene, a sentiment of each scene, an ambient of each scene, and a geo-location of each scene.

6. The system of claim 1, wherein the one or more processors are configured to perform operations further comprising:
receiving user data associated with a target audience for the media content; and
updating the one or more suggested content modifications based on the user data.

7. The system of claim 1, wherein the one or more processors are configured to perform operations further comprising:
updating the one or more suggested content modifications based on auxiliary data comprising at least one of a cast of the media content, a sponsor of the media content, and a target geographic region of the media content.

8. The system of claim 1, wherein the one or more suggested content modifications comprise an interactive element providing information associated with the at least one of the object, the activity, and the dialogue.

9. The system of claim 1, wherein the one or more processors are configured to perform operations further comprising:
updating the one or more suggested content modifications based on rules that prohibit one or more types of content being used to modify the at least one of the object, the activity, and the dialogue.

10. A method comprising:
receiving content script text descriptive of one or more scenes associated with media content, the content script text being external to the media content;
based on the content script text, determining, by an artificial intelligence model, one or more contextual attributes of each scene from the one or more scenes;
based on the one or more contextual attributes, determining one or more content placement locations within the one or more scenes, the one or more content placement locations depicting at least one of an object, an activity, and a dialogue; and
generating one or more suggested content modifications for the at least one of the object, the activity, and the dialogue in the one or more content placement locations within the one or more scenes.

11. The method of claim 10, wherein the media content comprises a plurality of frames, and the method further comprises:
based on a determination that the one or more scenes are depicted in one or more frames from the plurality of frames, identifying the one or more content placement locations from the one or more frames depicting the one or more scenes, wherein the one or more frames also depict the at least one of the object, the activity, and the dialogue.

12. The method of claim 11, further comprising:
replacing, using a generative model, the object in the one or more frames with content associated with the one or more suggested content modifications.

13. The method of claim 10, wherein the one or more suggested content modifications comprise one or more content characteristics comprising at least one of a content genre, a content duration, a frequency of appearances of the object, the activity, and the dialogue in the media content, and one or more content constraints.

14. The method of claim 10, wherein the one or more contextual attributes comprise at least one of a genre of each scene, one or more characters in each scene, a relationship between characters in each scene, a gender of the one or more characters, an age of the one or more characters, a background audio of each scene, a sentiment of each scene, an ambient of each scene, and a geo-location of each scene.

15. The method of claim 10, further comprising:
receiving user data associated with a target audience for the media content; and
updating the one or more suggested content modifications based on the user data.

16. The method of claim 10, further comprising:
updating the one or more suggested content modifications based on auxiliary data comprising at least one of a cast of the media content, a sponsor of the media content, and a target geographic region of the media content.

17. The method of claim 10, wherein the one or more suggested content modifications comprise an interactive element providing information associated with the at least one of the object, the activity, and the dialogue.

18. The method of claim 10, further comprising:
updating the one or more suggested content modifications based on rules that prohibit one or more types of content being used to modify the at least one of the object, the activity, and the dialogue.

19. A non-transitory computer-readable medium having instructions stored thereon that, when executed by one or more processors, cause the one or more processors to perform operations comprising:
receiving content script text descriptive of one or more scenes associated with media content, the content script text being external to the media content;
based on the content script text, determining, by an artificial intelligence model, one or more contextual attributes of each scene from the one or more scenes;
based on the one or more contextual attributes, determining one or more content placement locations within the one or more scenes, the one or more content placement locations depicting at least one of an object, an activity, and a dialogue; and
generating one or more suggested content modifications for the at least one of the object, the activity, and the dialogue in the one or more content placement locations within the one or more scenes.

20. The non-transitory computer-readable medium of claim 19, wherein the media content comprises a plurality of frames, and wherein the instructions cause the one or more processors to perform operations comprising:
based on a determination that the one or more scenes are depicted in one or more frames from the plurality of frames, identifying the one or more content placement locations from the one or more frames depicting the one or more scenes, wherein the one or more frames also depict the at least one of the object, the activity, and the dialogue.
